(19) United States
(12) Patent Application Publication
(10) Pub. No.: US 2017/0206007 A1
(43) Pub. Date: Jul. 20, 2017

(54) MEMORY SYSTEM AND OPERATING METHOD OF MEMORY SYSTEM

(71) Applicant: SK hynix Inc., Gyeonggi-do (KR)

(72) Inventor: Beom-Ju SHIN, Gyeonggi-do (KR)

(21) Appl. No.: 15/192,761

(22) Filed: Jun. 24, 2016

(30) Foreign Application Priority Data
Jan. 14, 2016 (KR) 10-2016-0004725

(51) Int. Cl. G06F 3/06

(52) U.S. Cl. CPC G06F 3/061; G06F 3/0626; G06F 3/064; G06F 3/0659; G06F 3/0679

(57) ABSTRACT

This technology relates to a memory system for processing data into a memory device and an operating method of the memory system. The memory system may include a memory device; and a controller suitable for: performing a command operation to the memory device in response to a command, calculating a foreground operation workload corresponding to the command, calculating a memory available workload of the memory device for the command operation, and dynamically determining priority and workload for the command operation based on the foreground operation workload and the memory available workload.

### CROSS-REFERENCE TO RELATED APPLICATION

The present application claims priority under 35 U.S.C §119(a) of Korean Patent Application No. 10-2016-0004725, filed on Jan. 14, 2016, which is incorporated herein by reference in its entirety.

### BACKGROUND

1. Field

Exemplary embodiments of the present invention relate to a memory system including a memory device and an operating method of the memory system.

2. Description of the Related Art

The computer environment paradigm has shifted to ubiquitous computing systems that can be used anytime and anywhere. Due to this fact, use of portable electronic devices, such as, mobile phones, digital cameras, and notebook computers has rapidly increased. These portable electronic devices generally employ a memory system having one or more memory devices as a data storage device. The memory system is used as a main memory device or an auxiliary memory device of the portable electronic devices.

Memory systems using memory devices provide excellent stability, durability, high information access speed, and low power consumption, since they have no moving parts. Examples of memory systems having such advantages include universal serial bus (USB) memory devices, memory cards having various interfaces, and solid state drives (SSD).

### SUMMARY

Various embodiments are directed to a memory system with minimized complexity and performance degradation and capable of maximizing use efficiency of a memory device, and an operating method of the memory system.

In an embodiment, a memory system, may include: a memory device; and a controller suitable for: performing a command operation to the memory device in response to a command, calculating a foreground operation workload corresponding to the command, calculating a memory available workload of the memory device for the command operation, and dynamically determining priority and workload for the command operation based on the foreground operation workload and the memory available workload.

The command may include at least one of a read command and a write command, and the foreground operation workload may include at least one of a foreground read operation workload corresponding to the read command and a foreground write operation workload corresponding to the write command.

The command operation may include a read operation and a write operation, and the memory available workload may include a read memory available workload for the read operation and a write memory available workload for the write operation.

The controller may further calculate a background operation workload of the memory device involved with a currently performed background operation.

The controller may further calculate a maximum read and write memory available workloads of the memory device based on a parameter of the memory device for the read and write operations, the background operation workload, and the foreground read and write operation workloads.

The controller may dynamically determine priorities and workloads for the read and write operations based on the maximum read and write memory available workloads and the read and write memory available workloads.

The memory device may include a plurality of pages, a plurality of memory blocks comprising the plurality of pages, a plurality of planes comprising the plurality of memory blocks, and a plurality of memory dies comprising the plurality of plane; and the controller may determine a size or number of at least one of the memory dies, planes, memory blocks, and pages as the workloads for the read and write operations.

The controller may determine the maximum read memory available workload as the workload for the read operation when only the read command is provided from the host, and the controller may determine the maximum write memory available workload as the workload for the write operation when only the write command is provided from the host.

The controller may adjust the workloads for the read and write operations based on the read and write memory available workloads for the read and write operations.

The controller may include: a first calculation unit suitable for calculating the foreground read and write operation workloads; a second calculation unit suitable for calculating the background operation workload; a monitoring unit suitable for calculating the read and write memory available workloads by monitoring the read and write operations; a computation unit suitable for calculating the maximum read and write memory available workloads; and a scheduling unit suitable for dynamically determining the priorities and workloads for the read and write operations.

The parameter may include: a size and time interval of the memory device for the read operation, and a size and time interval of the memory device for the write operation.

In an embodiment, an operating method of a memory system having a memory device, the method may include: performing a command operation to the memory device in response to a command, calculating a foreground operation workload corresponding to the command, calculating a memory available workload of the memory device for the command operation, and dynamically determining priority and workload for the command operation based on the foreground operation workload and the memory available workload.

The command may include at least one of a read command and a write command, the foreground operation workload may include at least one of a foreground read operation workload corresponding to the read command and a foreground write operation workload corresponding to the write command, the command operation may include at least one of a read operation and a write operation, and the memory available workload may include at least one of a read memory available workload for the read operation and a write memory available workload for the write operation.

The operating method may further include calculating a background operation workload of the memory device involved with a currently performed background operation.

The operating method may further include calculating a maximum read and write memory available workloads of the memory device based on a parameter of the memory device for the read and write operations, the background operation workload, and the foreground read and write operation workloads.

The dynamically determining of the priority and workloads for the command operation may include determining priorities and workloads for the read and write operations based on the maximum read and write memory available workloads and the read and write memory available workloads.

The memory device may include a plurality of pages, a plurality of memory blocks comprising the plurality of pages, a plurality of planes comprising the plurality of memory blocks, and a plurality of memory dies comprising the plurality of planes, and the dynamically determining of the workloads for the command operation may be performed by determining a size or number of at least one of the memory dies, planes, memory blocks, and pages as the workloads for the read and write operations.

The dynamically determining of the workloads for the command operation may be performed by determining the maximum read memory available workload as the workload for the read operation when only the read command is provided from the host, and the dynamically determining of the workloads for the command operation may be performed by determining the maximum write memory available workload as the workload for the write operation when only the write command is provided from the host.

The dynamically determining of the workloads for the command operation may include adjusting the workloads for the read and write operations based on the read and write memory available workloads for the read and write operations.

The parameter may include: a size and time interval of the memory device for the read operation, and a size and time interval of the memory device for the write operation.

### BRIEF DESCRIPTION OF THE DRAWINGS

FIG. 1 is a diagram illustrating a data processing system including a memory system, according to an embodiment of the present invention.

FIG. 2 is a diagram illustrating an example of a memory device employed in the memory system of FIG. 1.

FIG. 3 is a circuit diagram illustrating a memory block in a memory device, according to an embodiment of the present invention.

FIGS. 4 to 11 are diagrams schematically illustrating various aspects of the memory device of FIG. 2.

FIG. 12 is a schematic diagram illustrating an example of a data processing operation for a memory device in the memory system of FIG. 1, according to an embodiment of the present invention.

FIG. 13 is a flowchart illustrating an operational process of the memory system of FIG. 1, according to an embodiment of the present invention.

### DETAILED DESCRIPTION

Various embodiments will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the present invention to those skilled in the art. Throughout the disclosure, like reference numerals refer to like parts throughout the various figures and embodiments of the present invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention. As used herein, singular forms are intended to include the plural forms as well, unless the context clearly indicates otherwise. It will be further understood that the terms “comprises,” “comprising,” “includes,” and “including” when used in this specification, specify the presence of the stated elements and do not preclude the presence or addition of one or more other elements. As used herein, the term “and/or” Includes any and all combinations of one or more of the associated listed items.

Unless otherwise defined, all terms including technical and scientific terms used herein have the same meaning as commonly understood by one of ordinary skill in the art to which the present invention belongs. It will be further understood that terms, such as, for example, those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

Hereinafter, the various embodiments of the present invention will be described in detail with reference to the attached drawings.

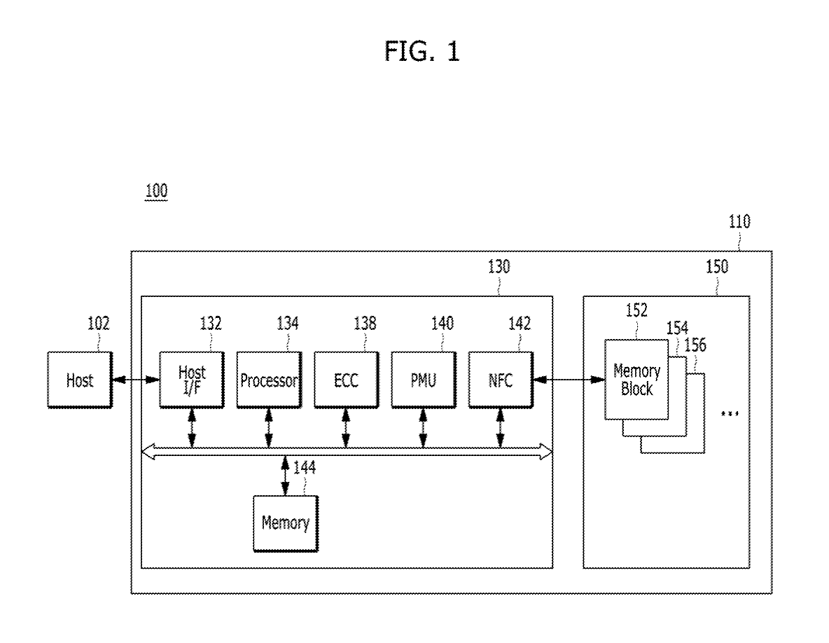

Referring now to FIG. 1 a data processing system including a memory system is provided, according to an embodiment of the invention.

According to the embodiment of FIG. 1, a data processing system 100 may include a host 102 and a memory system 110.

The host 102 may include, for example, a portable electronic device such as a mobile phone, an MP3 player and a laptop computer or an electronic device such as a desktop computer, a game player, a TV and a projector.

The memory system 110 may operate in response to a request from the host 102. For example, the memory system 110 may store data to be accessed by the host 102. The memory system 110 may be used as a main memory system or an auxiliary memory system of the host 102. The memory system 110 may be implemented with any one of various storage devices, according to the protocol of a host interface to be electrically coupled with the host 102. The memory system 110 may be implemented with any one of various storage devices, such as, a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and so forth.

The storage devices for the memory system 110 may be implemented with a volatile memory device, such as, a dynamic random access memory (DRAM) and a static random access memory (SRAM) or a nonvolatile memory device, such as, a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM) and a resistive RAM (RRAM).

The memory system 110 may include a memory device 150 which stores data to be accessed by the host 102, and a controller 130 which may control storage of data in the memory device 150.

The controller 130 and the memory device 150 may be integrated into one semiconductor device. For instance, the controller 130 and the memory device 150 may be integrated into one semiconductor device and configure a solid state drive (SSD). When the memory system 110 is used as the SSD, the operation speed of the host 102 that is electrically coupled with the memory system 110 may be significantly increased.

The controller 130 and the memory device 150 may be integrated into one semiconductor device and configure a memory card. The controller 130 and the memory card 150 may be integrated into one semiconductor device and configure a memory card, such as, for example, a Personal Computer Memory Card International Association (PCMCIA) card, a compact flash (CF) card, a smart media (SM) card (SMC), a memory stick, a multimedia card (MMC), an RS-MMC and a micro-MMC, a secure digital (SD) card, a mini-SD, a micro-SD and an SDHC, and a universal flash storage (UFS) device.

For another instance, the memory system 110 may configure a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a three-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, an RFID device, or one of various component elements configuring a computing system.

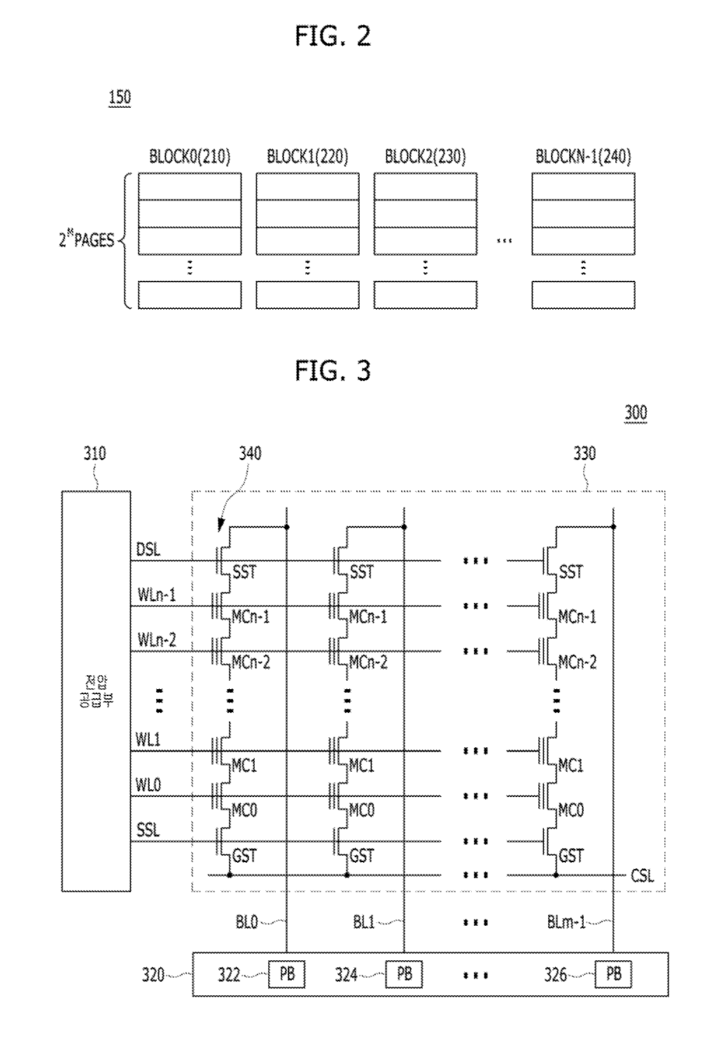

The memory device 150 of the memory system 110 may retain stored data when power supply is interrupted and, in particular, store the data provided from the host 102 during a write operation, and provide stored data to the host 102 during a read operation. The memory device 150 may include a plurality of memory blocks 152, 154 and 156. Each of the memory blocks 152, 154 and 156 may include a plurality of pages. Each of the pages may include a plurality of memory cells to which a plurality of word lines (WL) are electrically coupled. The memory device 150 may be a nonvolatile memory device, for example, a flash memory. The flash memory may have a three-dimensional (3D) stack structure. The structure of the memory device 150 and the three-dimensional (3D) stack structure of the memory device 150 will be described later in detail with reference to FIGS. 2 to 11.

The controller 130 of the memory system 110 may control the memory device 150 in response to a request from the host 102. The controller 130 may provide the data read from the memory device 150, to the host 102, and store the data provided from the host 102 into the memory device 150. To this end, the controller 130 may control overall operations of the memory device 150, such as, read, write, program and erase operations.

In detail, the controller 130 may include a host interface unit 132, a processor 134, an error correction code (ECC) unit 138, a power management unit 140, a NAND flash controller 142, and a memory 144.

The host interface unit 132 may process commands and data provided from the host 102, and may communicate with the host 102 through at least one of various interface protocols such as universal serial bus (USB), multimedia card (MMC), peripheral component interconnect-express (PCI-E), serial attached SCSI (SAS), serial advanced technology attachment (SATA), parallel advanced technology attachment (PATA), small computer system interface (SCSI), enhanced small disk interface (ESDI), and integrated drive electronics (IDE).

The ECC unit 138 may detect and correct errors in the data read from the memory device 150 during the read operation. The ECC unit 138 may not correct error bits when the number of the error bits is greater than or equal to a threshold number of correctable error bits, and may output an error correction fail signal indicating failure in correcting the error bits.

The ECC unit 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC unit 138 may include all circuits, systems or devices for the error correction operation.

The PMU 140 may provide and manage power for the controller 130, that is, power for the component elements included in the controller 130.

The NFC 142 may serve as a memory interface between the controller 130 and the memory device 150 to allow the controller 130 to control the memory device 150 in response to a request from the host 102. The NFC 142 may generate control signals for the memory device 150 and process data under the control of the processor 134 when the memory device 150 is a flash memory and, in particular, when the memory device 150 is a NAND flash memory.

The memory 144 may serve as a working memory of the memory system 110 and the controller 130, and store data for driving the memory system 110 and the controller 130. The controller 130 may control the memory device 150 in response to a request from the host 102. For example, the controller 130 may provide the data read from the memory device 150 to the host 102 and store the data provided from the host 102 in the memory device 150. When the controller 130 controls the operations of the memory device 150, the memory 144 may store data used by the controller 130 and the memory device 150 for such operations as read, write, program and erase operations.

The memory 144 may be implemented with volatile memory. The memory 144 may be implemented with a static random access memory (SRAM) or a dynamic random access memory (DRAM). As described above, the memory 144 may store data used by the host 102 and the memory device 150 for the read and write operations. To store the data, the memory 144 may include a program memory, a data memory, a write buffer, a read buffer, a map buffer, and so forth.

The processor 134 may control general operations of the memory system 110, and a write operation or a read operation for the memory device 150, in response to a write request or a read request from the host 102. The processor 134 may drive firmware, which is referred to as a flash translation layer (FTL), to control the general operations of the memory system 110. The processor 134 may be implemented with a microprocessor or a central processing unit (CPU).

A management unit (not shown) may be included in the processor 134, and may perform bad block management of the memory device 150. The management unit may find bad memory blocks included in the memory device 150, which are in unsatisfactory condition for further use, and perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. Also, the bad blocks due to the program fail seriously deteriorates the utilization efficiency of the memory device 150 having a 3D stack structure and the reliability of the memory system 100, and thus reliable bad block management is required.

FIG. 2 is a schematic diagram illustrating the memory device 150 of FIG. 1.

According to the embodiment of FIG. 2, the memory device 150 may include a plurality of memory blocks, for example, zeroth to (N−1)^{th} blocks 210 to 240. Each of the plurality of memory blocks 210 to 240 may include a plurality of pages, for example, 2^{M} number of pages (2^{M} PAGES), to which the present invention will not be limited. Each of the plurality of pages may include a plurality of memory cells to which a plurality of word lines are electrically coupled.

Also, the memory device 150 may include a plurality of memory blocks, as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data, for example, two or more-bit data. An MLC memory block including a plurality of pages which are implemented with memory cells that are each capable of storing 3-bit data may be defined as a triple level cell (TLC) memory block.

Each of the plurality of memory blocks 210 to 240 may store the data provided from the host device 102 during a write operation, and may provide stored data to the host 102 during a read operation.

FIG. 3 is a circuit diagram illustrating one of the plurality of memory blocks 152 to 156 of FIG. 1.

According to the embodiment of FIG. 3, the memory block 152 of the memory device 150 may include a plurality of cell strings 340 which are electrically coupled to bit lines BL0 to BLm−1, respectively. The cell string 340 of each column may include at least one drain select transistor DST and at least one source select transistor SST. A plurality of memory cells or a plurality of memory cell transistors MC0 to MCn−1 may be electrically coupled in series between the select transistors DST and SST. The respective memory cells MC0 to MCn−1 may be configured by multi-level cells (MLC) each of which stores data information of a plurality of bits. The strings 340 may be electrically coupled to the corresponding bit lines BL0 to BLm−1, respectively. For reference, in FIG. 3, ‘DSL’ denotes a drain select line, ‘SSL’ denotes a source select line, and ‘CSL’ denotes a common source line.

While FIG. 3 shows, as an example, the memory block 152 which is configured by NAND flash memory cells, it is to be noted that the memory block 152 of the memory device 150 according to the embodiment is not limited to NAND flash memory and may be realized by NOR flash memory, hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A voltage supply block 310 of the memory device 150 may provide word line voltages, for example, a program voltage, a read voltage and a pass voltage, to be supplied to respective word lines according to an operation mode and voltages to be supplied to bulks, for example, well regions in which the memory cells are formed. The voltage supply block 310 may perform a voltage generating operation under the control of a control circuit (not shown). The voltage supply block 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read/write circuit 320 of the memory device 150 may be controlled by the control circuit, and may serve as a sense amplifier or a write driver according to an operation mode. During a verification/normal read operation, the read/write circuit 320 may serve as a sense amplifier for reading data from the memory cell array. Also, during a program operation, the read/write circuit 320 may serve as a write driver which drives bit lines according to data to be stored in the memory cell array. The read/write circuit 320 may receive data to be written in the memory cell array, from a buffer (not shown), during the program operation, and may drive the bit lines according to the inputted data. To this end, the read/write circuit 320 may include a plurality of page buffers 322, 324 and 326 respectively corresponding to columns (or bit lines) or pairs of columns (or pairs of bit lines), and a plurality of latches (not shown) may be included in each of the page buffers 322, 324 and 326.

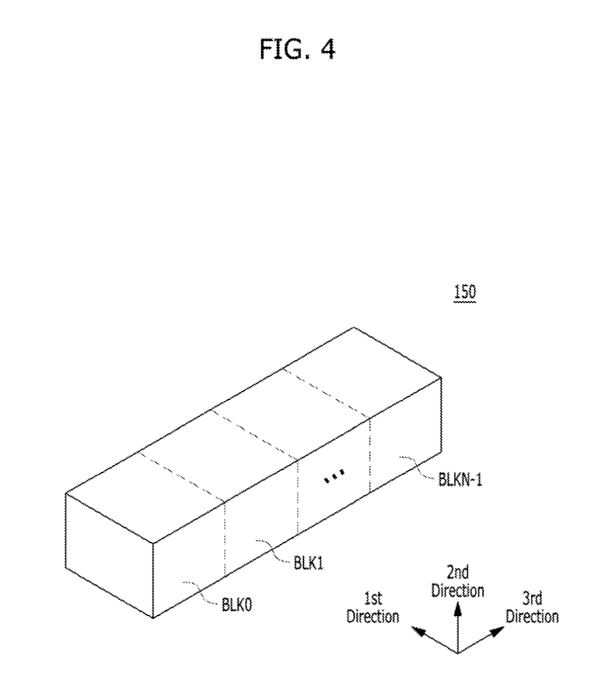

FIGS. 4 to 11 are schematic diagrams illustrating the memory device 150 of FIG. 1.

FIG. 4 is a block diagram illustrating an example of the plurality of memory blocks 152 to 156 of the memory device 150 of FIG. 1.

According to the embodiment of FIG. 4, the memory device 150 may include a plurality of memory blocks BLK0 to BLKN−1, and each of the memory blocks BLK0 to BLKN−1 may be realized in a three-dimensional (3D) structure or a vertical structure. The respective memory blocks BLK0 to BLKN−1 may include structures which extend in first to third directions, for example, an x-axis direction, a y-axis direction and a z-axis direction.

The respective memory blocks BLK0 to BLKN−1 may include a plurality of NAND strings NS extending in the second direction. The plurality of NAND strings NS may be provided in the first direction and the third direction. Each NAND string NS may be electrically coupled to a bit line BL, at least one source select line SSL, at least one ground select line GSL, a plurality of word lines WL, at least one dummy word line DWL, and a common source line CSL. Namely, the respective memory blocks BLK0 to BLKN−1 may be electrically coupled to a plurality of bit lines BL, a plurality of source select lines SSL, a plurality of ground select lines GSL, a plurality of word lines WL, a plurality of dummy word lines DWL, and a plurality of common source lines CSL.

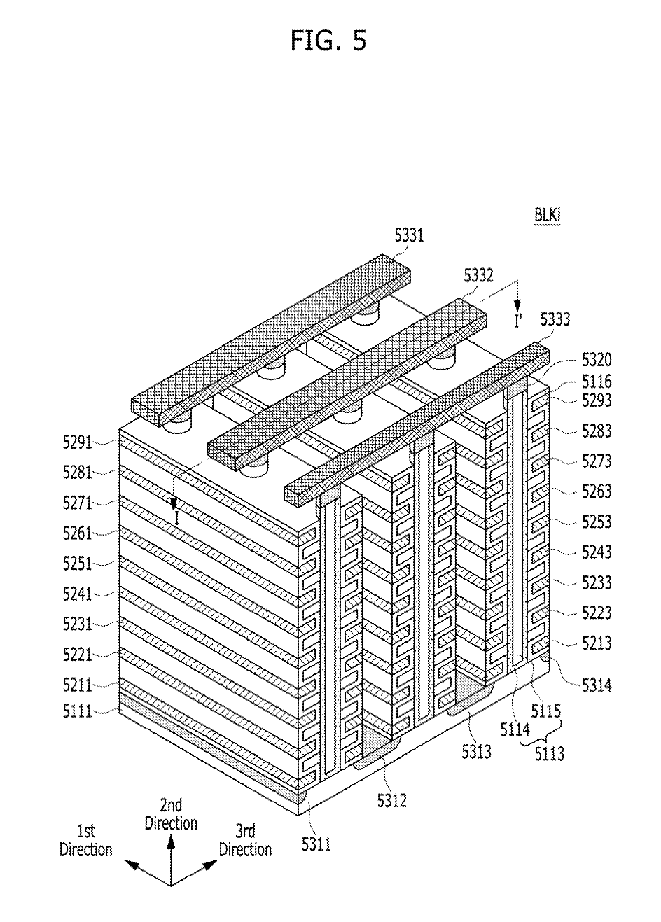

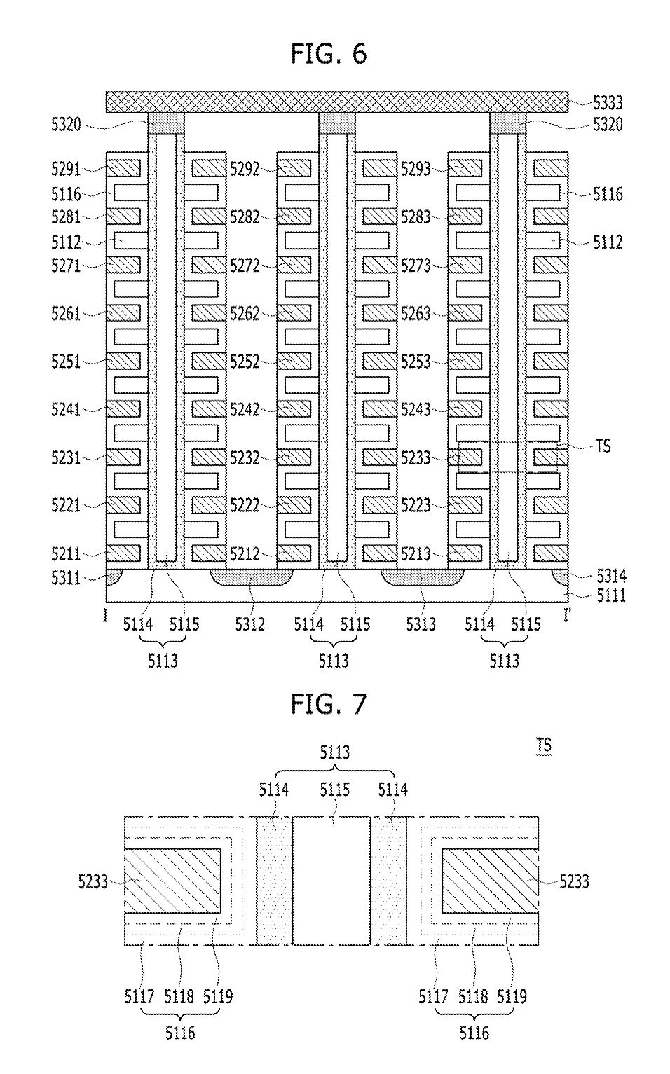

FIG. 5 is a perspective view of one BLKi of the plural memory blocks BLK0 to BLKN−1 of FIG. 4. FIG. 6 is a cross-sectional view taken along a line I-I′ of the memory block BLKi of FIG. 5.

According to the embodiment of FIGS. 5 and 6, a memory block BLKi among the plurality of memory blocks of the memory device 150 may include a structure which extends in the first to third directions.

A substrate 5111 may be provided. The substrate 5111 may include a silicon material doped with a first type impurity. The substrate 5111 may include a silicon material doped with a p-type impurity or may be a p-type well, for example, a pocket p-well, and include an n-type well which surrounds the p-type well. While it is assumed that the substrate 5111 is p-type silicon, it is to be noted that the substrate 5111 is not limited to being p-type silicon.

A plurality of doping regions 5311 to 5314 extending in the first direction may be provided over the substrate 5111. The plurality of doping regions 5311 to 5314 may contain a second type of impurity that is different from the substrate 5111. The plurality of doping regions 5311 to 5314 may be doped with an n-type impurity. While it is assumed here that first to fourth doping regions 5311 to 5314 are n-type, it is to be noted that the first to fourth doping regions 5311 to 5314 are not limited to being n-type.

In the region over the substrate 5111 between the first and second doping regions 5311 and 5312, a plurality of dielectric materials 5112 extending in the first direction may be sequentially provided in the second direction. The dielectric materials 5112 and the substrate 5111 may be separated from one another by a predetermined distance in the second direction. The dielectric materials 5112 may be separated from one another by a predetermined distance in the second direction. The dielectric materials 5112 may include a dielectric material, such as, silicon oxide.

In the region over the substrate 5111 between the first and second doping regions 5311 and 5312, a plurality of pillars 5113 which are sequentially disposed in the first direction and pass through the dielectric materials 5112 in the second direction may be provided. The plurality of pillars 5113 may respectively pass through the dielectric materials 5112 and may be electrically coupled with the substrate 5111. Each pillar 5113 may be configured by a plurality of materials. The surface layer 5114 of each pillar 5113 may include a silicon material doped with the first type of impurity. The surface layer 5114 of each pillar 5113 may include a silicon material doped with the same type of impurity as the substrate 5111. While it is assumed here that the surface layer 5114 of each pillar 5113 may include p-type silicon, the surface layer 5114 of each pillar 5113 is not limited to being p-type silicon.

An inner layer 5115 of each pillar 5113 may be formed of a dielectric material. The inner layer 5115 of each pillar 5113 may be filled by a dielectric material, such as, silicon oxide.

In the region between the first and second doping regions 5311 and 5312, a dielectric layer 5116 may be provided along the exposed surfaces of the dielectric materials 5112, the pillars 5113 and the substrate 5111. The thickness of the dielectric layer 5116 may be less than half of the distance between the dielectric materials 5112. In other words, a region in which a material other than the dielectric material 5112 and the dielectric layer 5116 may be disposed, may be provided between (i) the dielectric layer 5116 provided over the bottom surface of a first dielectric material of the dielectric materials 5112 and (ii) the dielectric layer 5116 provided over the top surface of a second dielectric material of the dielectric materials 5112. The dielectric materials 5112 lie below the first dielectric material.

In the region between the first and second doping regions 5311 and 5312, conductive materials 5211 to 5291 may be provided over the exposed surface of the dielectric layer 5116. The conductive material 5211 which extends in the first direction may be provided between the dielectric material 5112 adjacent to the substrate 5111 and the substrate 5111. In particular, the conductive material 5211 which extends in the first direction may be provided between (i) the dielectric layer 5116 disposed over the substrate 5111 and (ii) the dielectric layer 5116 disposed over the bottom surface of the dielectric material 5112 adjacent to the substrate 5111.

The conductive material which extends in the first direction may be provided between (i) the dielectric layer 5116 disposed over the top surface of one of the dielectric materials 5112 and (ii) the dielectric layer 5116 disposed over the bottom surface of another dielectric material of the dielectric materials 5112, which is disposed over the certain dielectric material 5112. The conductive materials 5221 to 5281 extending in the first direction may be provided between the dielectric materials 5112. The conductive material 5291 which extends in the first direction may be provided over the uppermost dielectric material 5112. The conductive materials 5211 to 5291 extending in the first direction may be a metallic material. The conductive materials 5211 to 5291 extending in the first direction may be a conductive material, such as, polysilicon.

In the region between the second and third doping regions 5312 and 5313, the same structures as the structures between the first and second doping regions 5311 and 5312 may be provided. For example, in the region between the second and third doping regions 5312 and 5313, the plurality of dielectric materials 5112 extending in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5212 to 5292 extending in the first direction may be provided.

In the region between the third and fourth doping regions 5313 and 5314, the same structures as between the first and second doping regions 5311 and 5312 may be provided. For example, in the region between the third and fourth doping regions 5313 and 5314, the plurality of dielectric materials 5112 extending in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5213 to 5293 extending in the first direction may be provided.

Drains 5320 may be respectively provided over the plurality of pillars 5113. The drains 5320 may be silicon materials doped with second type impurities. The drains 5320 may be silicon materials doped with n-type impurities. While it is assumed for the sake of convenience that the drains 5320 include n-type silicon, it is to be noted that the drains 5320 are not limited to being n-type silicon. For example, the width of each drain 5320 may be larger than the width of each corresponding pillar 5113. Each drain 5320 may be provided in the shape of a pad over the top surface of each corresponding pillar 5113.

Conductive materials 5331 to 5333 extending in the third direction may be provided over the drains 5320. The conductive materials 5331 to 5333 may be sequentially disposed in the first direction. The respective conductive materials 5331 to 5333 may be electrically coupled with the drains 5320 of corresponding regions. The drains 5320 and the conductive materials 5331 to 5333 extending in the third direction may be electrically coupled with through contact plugs. The conductive materials 5331 to 5333 extending in the third direction may be a metallic material. The conductive materials 5331 to 5333 extending in the third direction may be a conductive material such as polysilicon.

In FIGS. 5 and 6, the respective pillars 5113 may form strings together with the dielectric layer 5116 and the conductive materials 5211 to 5291, 5212 to 5292 and 5213 to 5293 extending in the first direction. The respective pillars 5113 may form NAND strings NS together with the dielectric layer 5116 and the conductive materials 5211 to 5291, 5212 to 5292 and 5213 to 5293 extending in the first direction. Each NAND string NS may include a plurality of transistor structures TS.

FIG. 7 is a cross-sectional view of the transistor structure TS of FIG. 6.

According to the embodiment of FIG. 7, in the transistor structure TS of FIG. 6, the dielectric layer 5116 may include first to third sub dielectric layers 5117, 5118 and 5119.

The surface layer 5114 of p-type silicon in each of the pillars 5113 may serve as a body. The first sub dielectric layer 5117 adjacent to the pillar 5113 may serve as a tunneling dielectric layer, and may include a thermal oxidation layer.

The second sub dielectric layer 5118 may serve as a charge storing layer. The second sub dielectric layer 5118 may serve as a charge capturing layer, and may include a nitride layer or a metal oxide layer such as an aluminum oxide layer, a hafnium oxide layer, or the like.

The third sub dielectric layer 5119 adjacent to the conductive material 5233 may serve as a blocking dielectric layer. The third sub dielectric layer 5119 adjacent to the conductive material 5233 which extends in the first direction may be formed as a single layer or multiple layers. The third sub dielectric layer 5119 may be a high-k dielectric layer such as an aluminum oxide layer, a hafnium oxide layer, or the like, which has a dielectric constant greater than the first and second sub dielectric layers 5117 and 5118.

The conductive material 5233 may serve as a gate or a control gate. That is, the gate or the control gate 5233, the blocking dielectric layer 5119, the charge storing layer 5118, the tunneling dielectric layer 5117 and the body 5114 may form a transistor or a memory cell transistor structure. For example, the first to third sub dielectric layers 5117 to 5119 may form an oxide-nitride-oxide (ONO) structure. In the embodiment, for the sake of convenience, the surface layer 5114 of p-type silicon in each of the pillars 5113 will be referred to as a body in the second direction.

The memory block BLKi may include the plurality of pillars 5113. Namely, the memory block BLKi may include the plurality of NAND strings NS. In detail, the memory block BLKi may include the plurality of NAND strings NS extending in the second direction or a direction perpendicular to the substrate 5111.

Each NAND string NS may include the plurality of transistor structures TS which are disposed in the second direction. At least one of the plurality of transistor structures TS of each NAND string NS may serve as a string source transistor SST. At least one of the plurality of transistor structures TS of each NAND string NS may serve as a ground select transistor GST.

The gates or control gates may correspond to the conductive materials 5211 to 5291, 5212 to 5292 and 5213 to 5293 extending in the first direction. In other words, the gates or the control gates may extend in the first direction and form word lines and at least two select lines, at least one source select line SSL and at least one ground select line GSL.

The conductive materials 5331 to 5333 extending in the third direction may be electrically coupled to one end of the NAND strings NS. The conductive materials 5331 to 5333 extending in the third direction may serve as bit lines BL. That is, in one memory block BLKi, the plurality of NAND strings NS may be electrically coupled to one bit line BL.

The second type doping regions 5311 to 5314 extending in the first direction may be provided to the other ends of the NAND strings NS. The second type doping regions 5311 to 5314 extending in the first direction may serve as common source lines CSL.

Namely, the memory block BLKi may include a plurality of NAND strings NS extending in a direction perpendicular to the substrate 5111, e.g., the second direction, and may serve as a NAND flash memory block, for example, of a charge capturing type memory, in which a plurality of NAND strings NS are electrically coupled to one bit line BL.

While it is illustrated in FIGS. 5 to 7 that the conductive materials 5211 to 5291, 5212 to 5292 and 5213 to 5293 extending in the first direction are provided in 9 layers, it is to be noted that the conductive materials 5211 to 5291, 5212 to 5292 and 5213 to 5293 extending in the first direction are not limited to being provided in 9 layers. For example, conductive materials extending in the first direction may be provided in 8 layers, 16 layers or any multiple of layers. In other words, in one NAND string NS, the number of transistors may be 8, 16 or more.

While it is illustrated in FIGS. 5 to 7 that 3 NAND strings NS are electrically coupled to one bit line BL, it is to be noted that the embodiment is not limited to having 3 NAND strings NS that are electrically coupled to one bit line BL. In the memory block BLKi, m number of NAND strings NS may be electrically coupled to one bit line BL, m being a positive integer. According to the number of NAND strings NS which are electrically coupled to one bit line BL, the number of conductive materials 5211 to 5291, 5212 to 5292 and 5213 to 5293 extending in the first direction and the number of common source lines 5311 to 5314 may be controlled as well.

Further, while it is illustrated in FIGS. 5 to 7 that 3 NAND strings NS are electrically coupled to one conductive material which extends in the first direction, it is to be noted that the embodiment is not limited to having 3 NAND strings NS electrically coupled to one conductive material which extends in the first direction. For example, n number of NAND strings NS may be electrically coupled to one conductive material which extends in the first direction, n being a positive integer. According to the number of NAND strings NS which are electrically coupled to one conductive material which extends in the first direction, the number of bit lines 5331 to 5333 may be controlled as well.

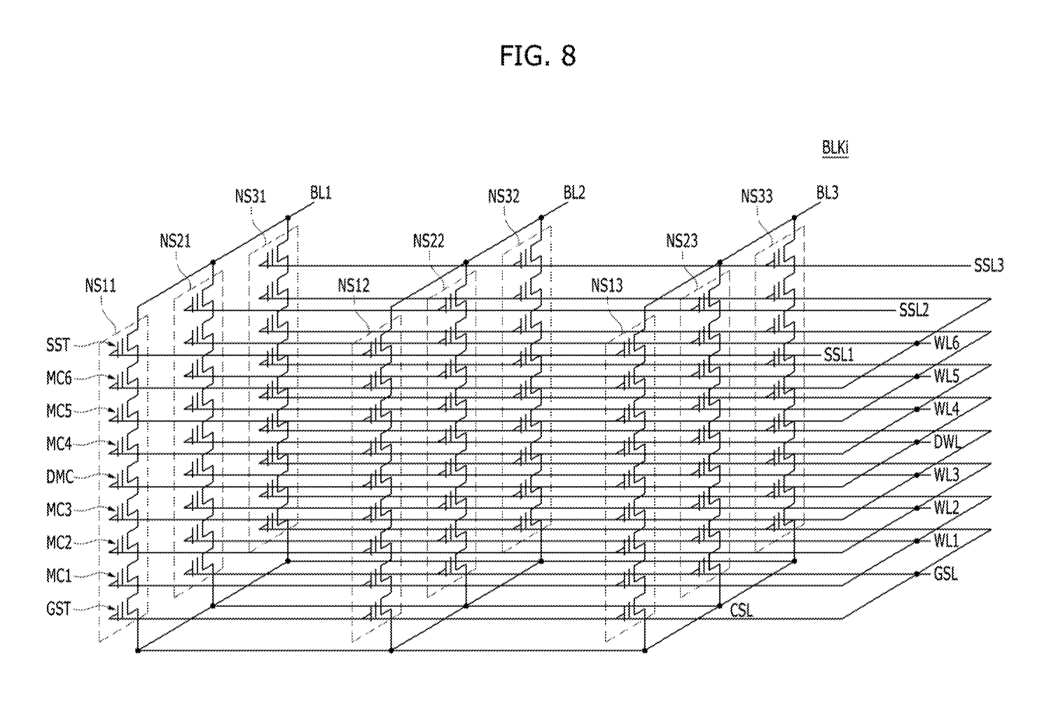

FIG. 8 is an equivalent circuit diagram illustrating the memory block BLKi having a first structure described with reference to FIGS. 5 to 7.

According to the embodiment of FIG. 8, in a block BLKi having the first structure, NAND strings NS11 to NS31 may be provided between a first bit line BL1 and a common source line CSL. The first bit line BL1 may correspond to the conductive material 5331 of FIGS. 5 and 6, which extends in the third direction. NAND strings NS12 to NS32 may be provided between a second bit line BL2 and the common source line CSL. The second bit line BL2 may correspond to the conductive material 5332 of FIGS. 5 and 6, which extends in the third direction. NAND strings NS13 to NS33 may be provided between a third bit line BL3 and the common source line CSL. The third bit line BL3 may correspond to the conductive material 5333 of FIGS. 5 and 6, which extends in the third direction.

A source select transistor SST of each NAND string NS may be electrically coupled to a corresponding bit line BL. A ground select transistor GST of each NAND string NS may be electrically coupled to the common source line CSL. Memory cells MC may be provided between the source select transistor SST and the ground select transistor GST of each NAND string NS.

In this example, NAND strings NS may be defined by units of rows and columns and NAND strings NS which are electrically coupled to one bit line may form one column. The NAND strings NS11 to NS31 which are electrically coupled to the first bit line BL1 may correspond to a first column, the NAND strings NS12 to NS32 which are electrically coupled to the second bit line BL2 may correspond to a second column, and the NAND strings NS13 to NS33 which are electrically coupled to the third bit line BL3 may correspond to a third column. NAND strings NS which are electrically coupled to one source select line SSL may form one row. The NAND strings NS11 to NS13 which are electrically coupled to a first source select line SSL1 may form a first row, the NAND strings NS21 to NS23 which are electrically coupled to a second source select line SSL2 may form a second row, and the NAND strings NS31 to NS33 which are electrically coupled to a third source select line SSL3 may form a third row.

In each NAND string NS, a height may be defined. In each NAND string NS, the height of a memory cell MC1 adjacent to the ground select transistor GST may have a value ‘1’. In each NAND string NS, the height of a memory cell may increase as the memory cell gets closer to the source select transistor SST when measured from the substrate 5111. In each NAND string NS, the height of a memory cell MC6 adjacent to the source select transistor SST may be 7.

The source select transistors SST of the NAND strings NS in the same row may share the source select line SSL. The source select transistors SST of the NAND strings NS in different rows may be respectively electrically coupled to the different source select lines SSL1, SSL2 and SSL3.

The memory cells at the same height in the NAND strings NS in the same row may share a word line WL. That is, at the same height, the word lines WL electrically coupled to the memory cells MC of the NAND strings NS in different rows may be electrically coupled. Dummy memory cells DMC at the same height in the NAND strings NS of the same row may share a dummy word line DWL. Namely, at the same height or level, the dummy word lines DWL electrically coupled to the dummy memory cells DMC of the NAND strings NS in different rows may be electrically coupled.

The word lines WL or the dummy word lines DWL located at the same level or height or layer may be electrically coupled with one another at layers where the conductive materials 5211 to 5291, 5212 to 5292 and 5213 to 5293 extending in the first direction may be provided. The conductive materials 5211 to 5291, 5212 to 5292 and 5213 to 5293 extending in the first direction may be electrically coupled in common to upper layers through contacts. At the upper layers, the conductive materials 5211 to 5291, 5212 to 5292 and 5213 to 5293 extending in the first direction may be electrically coupled. In other words, the ground select transistors GST of the NAND strings NS in the same row may share the ground select line GSL. Further, the ground select transistors GST of the NAND strings NS in different rows may share the ground select line GSL. That is, the NAND strings NS11 to NS13, NS21 to NS23 and NS31 to NS33 may be electrically coupled to the ground select line GSL.

The common source line CSL may be electrically coupled to the NAND strings NS. Over the active regions and over the substrate 5111, the first to fourth doping regions 5311 to 5314 may be electrically coupled. The first to fourth doping regions 5311 to 5314 may be electrically coupled to an upper layer through contacts and, at the upper layer, the first to fourth doping regions 5311 to 5314 may be electrically coupled.

Namely, as of FIG. 8, the word lines WL of the same height or level may be electrically coupled. Accordingly, when a word line WL at a specific height is selected, all NAND strings NS which are electrically coupled to the word line WL may be selected. The NAND strings NS in different rows may be electrically coupled to different source select lines SSL. Accordingly, among the NAND strings NS electrically coupled to the same word line WL, by selecting one of the source select lines SSL1 to SSL3, the NAND strings NS in the unselected rows may be electrically isolated from the bit lines BL1 to BL3. In other words, by selecting one of the source select lines SSL1 to SSL3, a row of NAND strings NS may be selected. Moreover, by selecting one of the bit lines BL1 to BL3, the NAND strings NS in the selected rows may be selected in units of columns.

In each NAND string NS, a dummy memory cell DMC may be provided. In FIG. 8, the dummy memory cell DMC may be provided between a third memory cell MC3 and a fourth memory cell MC4 in each NAND string NS. That is, first to third memory cells MC1 to MC3 may be provided between the dummy memory cell DMC and the ground select transistor GST. Fourth to sixth memory cells MC4 to MC6 may be provided between the dummy memory cell DMC and the source select transistor SST. The memory cells MC of each NAND string NS may be divided into memory cell groups by the dummy memory cell DMC. In the divided memory cell groups, memory cells, for example, MC1 to MC3, adjacent to the ground select transistor GST may be referred to as a lower memory cell group, and memory cells, for example, MC4 to MC6, adjacent to the string select transistor SST may be referred to as an upper memory cell group.

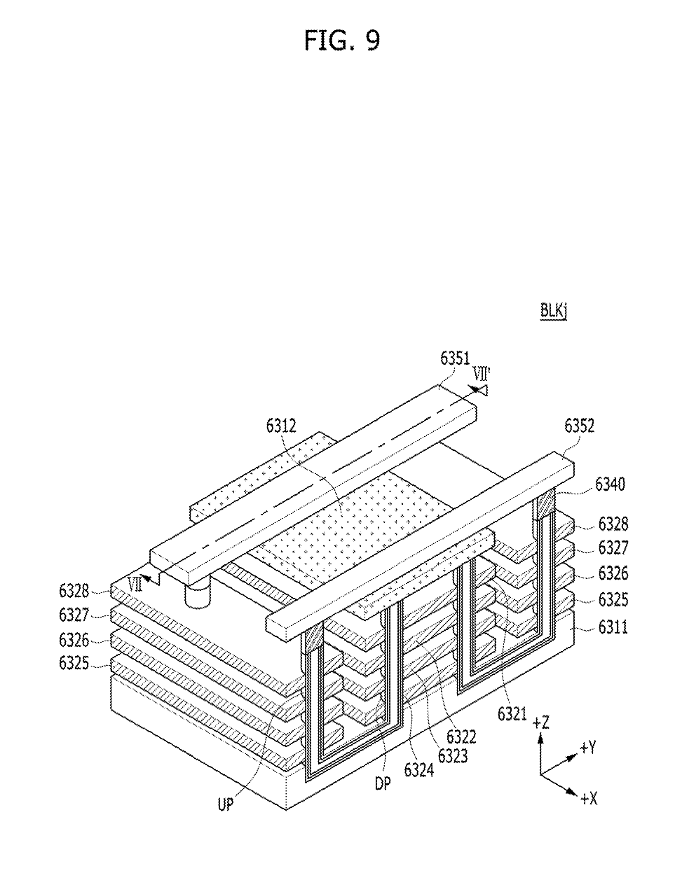

Hereinbelow, detailed descriptions will be made with reference to FIGS. 9 to 11, which show the memory device in the memory system according to an embodiment implemented with a three-dimensional (3D) nonvolatile memory device different from the first structure.

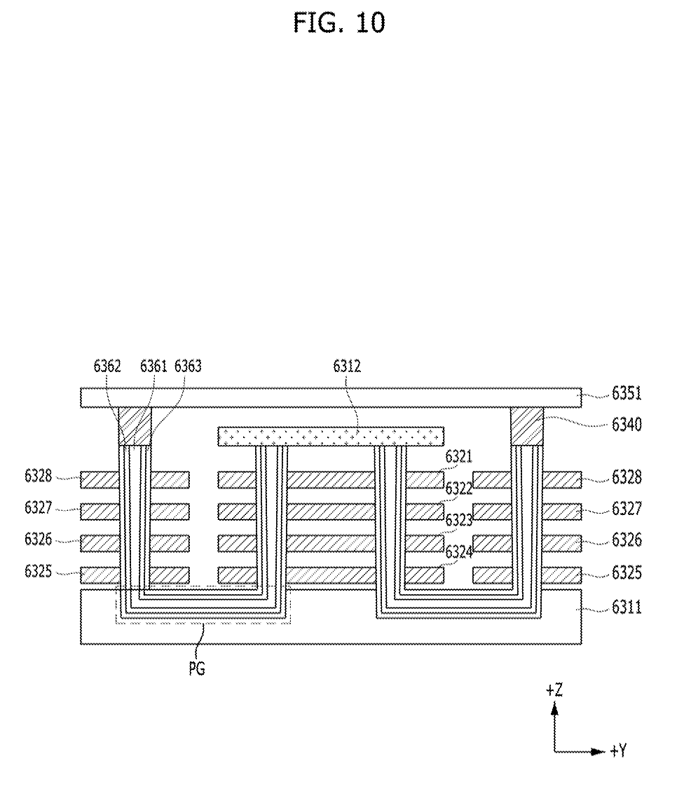

FIG. 9 is a perspective view schematically illustrating the memory device implemented with the three-dimensional (3D) nonvolatile memory device, which is different from the first structure described above with reference to FIGS. 5 to 8, and showing a memory block BLKj of the plurality of memory blocks of FIG. 4. FIG. 10 is a cross-sectional view illustrating the memory block BLKj taken along the line VII-VII′ of FIG. 9.

According to the embodiment of FIGS. 9 and 10, the memory block BLKj among the plurality of memory blocks of the memory device 150 of FIG. 1 may include structures extending in the first to third directions.

A substrate 6311 may be provided. For example, the substrate 6311 may include a silicon material doped with a first type impurity. For example, the substrate 6311 may include a silicon material doped with a p-type impurity or may be a p-type well, for example, a pocket p-well, and include an n-type well which surrounds the p-type well. While it is assumed in the embodiment for the sake of convenience that the substrate 6311 is p-type silicon, it is to be noted that the substrate 6311 is not limited to being p-type silicon.

First to fourth conductive materials 6321 to 6324 extending in the x-axis direction and the y-axis direction are provided over the substrate 6311. The first to fourth conductive materials 6321 to 6324 may be separated by a predetermined distance in the z-axis direction.

Fifth to eighth conductive materials 6325 to 6328 extending in the x-axis direction and the y-axis direction may be provided over the substrate 6311. The fifth to eighth conductive materials 6325 to 6328 may be separated by the predetermined distance in the z-axis direction. The fifth to eighth conductive materials 6325 to 6328 may be separated from the first to fourth conductive materials 6321 to 6324 in the y-axis direction.

A plurality of lower pillars DP which pass through the first to fourth conductive materials 6321 to 6324 may be provided. Each lower pillar DP extends in the z-axis direction. Also, a plurality of upper pillars UP which pass through the fifth to eighth conductive materials 6325 to 6328 may be provided. Each upper pillar UP extends in the z-axis direction.

Each of the lower pillars DP and the upper pillars UP may include an internal material 6361, an intermediate layer 6362, and a surface layer 6363. The intermediate layer 6362 may serve as a channel of the cell transistor. The surface layer 6363 may include a blocking dielectric layer, a charge storing layer and a tunneling dielectric layer.

The lower pillar DP and the upper pillar UP may be electrically coupled through a pipe gate PG. The pipe gate PG may be disposed in the substrate 6311. For instance, the pipe gate PG may include the same material as the lower pillar DP and the upper pillar UP.

A doping material 6312 of a second type which extends in the x-axis direction and the y-axis direction may be provided over the lower pillars DP. For example, the doping material 6312 of the second type may include an n-type silicon material. The doping material 6312 of the second type may serve as a common source line CSL.

Drains 6340 may be provided over the upper pillars UP. The drains 6340 may include an n-type silicon material. First and second upper conductive materials 6351 and 6352 extending in the y-axis direction may be provided over the drains 6340.

The first and second upper conductive materials 6351 and 6352 may be separated in the x-axis direction. The first and second upper conductive materials 6351 and 6352 may be formed of a metal. The first and second upper conductive materials 6351 and 6352 and the drains 6340 may be electrically coupled through contact plugs. The first and second upper conductive materials 6351 and 6352 respectively serve as first and second bit lines BL1 and BL2.

The first conductive material 6321 may serve as a source select line SSL, the second conductive material 6322 may serve as a first dummy word line DWL1, and the third and fourth conductive materials 6323 and 6324 serve as first and second main word lines MWL1 and MWL2, respectively. The fifth and sixth conductive materials 6325 and 6326 serve as third and fourth main word lines MWL3 and MWL4, respectively, the seventh conductive material 6327 may serve as a second dummy word line DWL2, and the eighth conductive material 6328 may serve as a drain select line DSL.

The lower pillar DP and the first to fourth conductive materials 6321 to 6324 adjacent to the lower pillar DP form a lower string. The upper pillar UP and the fifth to eighth conductive materials 6325 to 6328 adjacent to the upper pillar UP form an upper string. The lower string and the upper string may be electrically coupled through the pipe gate PG. One end of the lower string may be electrically coupled to the doping material 6312 of the second type which serves as the common source line CSL. One end of the upper string may be electrically coupled to a corresponding bit line through the drain 6340. One lower string and one upper string form one cell string which is electrically coupled between the doping material 6312 of the second type serving as the common source line CSL and a corresponding one of the upper conductive material layers 6351 and 6352 serving as the bit line BL.

That is, the lower string may include a source select transistor SST, the first dummy memory cell DMC1, and the first and second main memory cells MMC1 and MMC2. The upper string may include the third and fourth main memory cells MMC3 and MMC4, the second dummy memory cell DMC2, and a drain select transistor DST.

In FIGS. 9 and 10, the upper string and the lower string may form a NAND string NS, and the NAND string NS may include a plurality of transistor structures TS. Since the transistor structure included in the NAND string NS in FIGS. 9 and 10 is described above in detail with reference to FIG. 7, a detailed description thereof will be omitted herein.

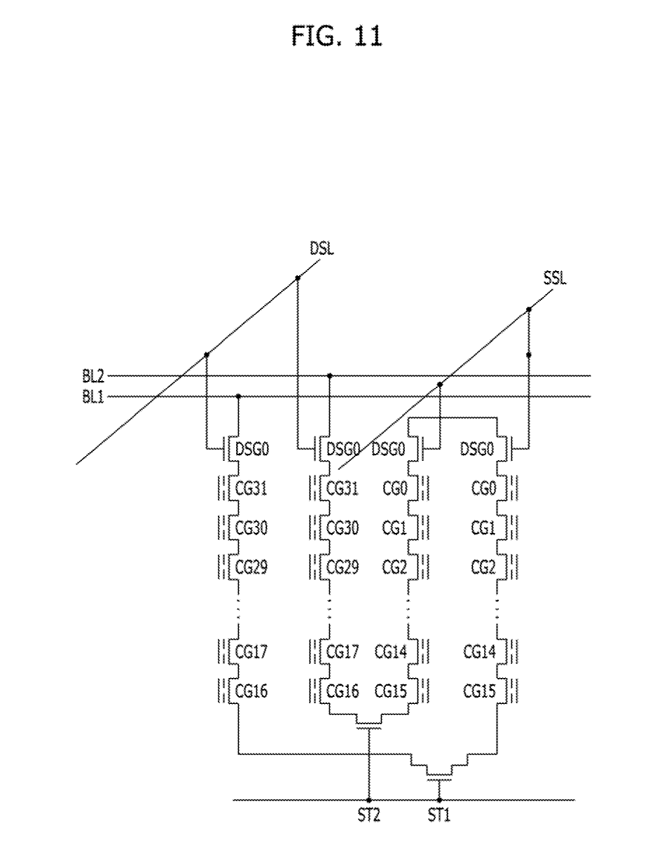

FIG. 11 is a circuit diagram illustrating the equivalent circuit of the memory block BLKj having the second structure as described above with reference to FIGS. 9 and 10. For the sake of convenience, only a first string and a second string, which form a pair in the memory block BLKj in the second structure are shown.

According to the embodiment of FIG. 11, in the memory block BLKj having the second structure among the plurality of blocks of the memory device 150, cell strings, each of which is implemented with one upper string and one lower string electrically coupled through the pipe gate PG as described above with reference to FIGS. 9 and 10, may be provided in such a way as to define a plurality of pairs.

Namely, in the certain memory block BLKj having the second structure, memory cells CG0 to CG31 stacked along a first channel CH1 (not shown), for example, at least one source select gate SSG1 and at least one drain select gate DSG1 may form a first string ST1, and memory cells CG0 to CG31 stacked along a second channel CH2 (not shown), for example, at least one source select gate SSG2 and at least one drain select gate DSG2 may form a second string ST2.

The first string ST1 and the second string ST2 may be electrically coupled to the same drain select line DSL and the same source select line SSL. The first string ST1 may be electrically coupled to a first bit line BL1, and the second string ST2 may be electrically coupled to a second bit line BL2.

While it is described in FIG. 11 that the first string ST1 and the second string ST2 are electrically coupled to the same drain select line DSL and the same source select line SSL, it may be envisaged that the first string ST1 and the second string ST2 may be electrically coupled to the same source select line SSL and the same bit line BL, the first string ST1 may be electrically coupled to a first drain select line DSL1 and the second string ST2 may be electrically coupled to a second drain select line DSL2. Further it may be envisaged that the first string ST1 and the second string ST2 may be electrically coupled to the same drain select line DSL and the same bit line BL, the first string ST1 may be electrically coupled to a first source select line SSL1 and the second string ST2 may be electrically coupled a second source select line SSL2.

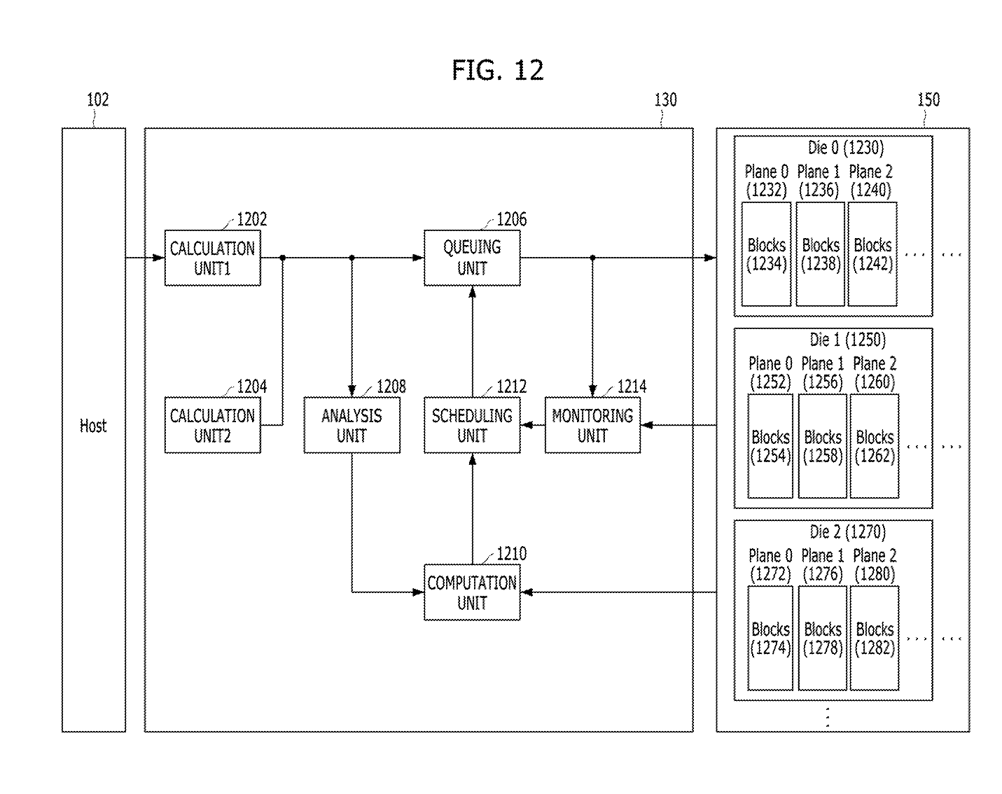

Referring to FIG. 12 a data processing operation to the memory device 150 in the memory system 110 of FIG. 1 is provided, according to an embodiment of the present invention.

According to the embodiment of FIG. 12, the controller 130 calculates a foreground operation workload required for a foreground operation, calculates a memory available workload of the memory device 150, i.e., memory that is available for the foreground operation, calculates a background operation workload required for a background operation which may be performed during the foreground operation, and determines priorities and workloads for the foreground operation in the memory device 150 based on the foreground operation workload, the memory available workload, and the background operation workload. A foreground operation, may, for example, be at least one of a read operation and a write operation. A background operation may, for example, be at least one of a garbage collection (GC) operation and a wear leveling (WL) operation.

In an embodiment of the present invention, the foreground operation workload may be categorized into a foreground read operation workload required for a read operation and a foreground write operation workload required for a write operation (also referred to as a program operation). Furthermore, the memory available workload may be categorized into a read memory available workload currently available for the read operation and a write memory available workload currently available for the write operation.

Furthermore, in an embodiment of the present invention, the controller 130 may dynamically prioritize the read and write operations to the memory device 150 and determine workloads for the read and write operations in the memory device 150 based on the foreground operation workload, the memory available workload, and the background operation workload. The controller 130 also may dynamically determine throughputs of the read operation and program operation.

In an embodiment of the present invention, the controller 130 may calculate a maximum read memory available workload and a maximum write memory available workload of the memory device 150 based on the capability (i.e., the memory available workload) of the memory device 150 for the read and write operations. In this case, when only a read command is provided from the host 102, the controller 130 performs the read operation on the memory device 150 based on the maximum read memory available workload. When only a write command is provided from the host 102, the controller 130 performs the program operation on the memory device 150 based on the maximum write memory available workload.

In an embodiment of the present invention, the controller 130 may calculate a foreground read workload, a foreground write workload based on the number of read and write commands and the storage capacity of memory dies, planes, memory blocks, or pages required for the read and write operations in the memory device 150.

Furthermore, in an embodiment of the present invention, the controller 130 may calculate the read and write memory available workloads based on the storage capacity of memory dies, planes, memory blocks, or pages involved with the currently to-be-performed read and write operations.

According to the embodiment of FIG. 12, the controller 130 may store user data corresponding to a write command in a specific memory block of a plurality of memory blocks included in a plurality of planes 1232 to 1280 included in a plurality of memory dies 1230 to 1270 included in the memory device 150.

The controller 130 includes a first calculation unit 1202 suitable for calculating the foreground operation workload required for one or more foreground operations such as, for example, a read and or a write operation in response to at least one of a read and a write command. The first calculation unit 1202 may, for example, calculate the foreground read operation workload during a read operation. The first calculation unit 1202 may, for example, calculate the foreground write operation workload during a program operation. The first calculation unit 1202, may calculate both a foreground read operation workload during a read operation and a write operation workload during a program operation. The first calculation unit 1202 may calculate as the foreground read operation workload the storage capacity of the memory blocks required for the read operation in the memory device 150. The first calculation unit 1202 may calculate as the foreground read operation workload the number of the read commands. The first calculation unit 1202 may calculate as the foreground write operation workload the storage capacity of memory blocks required for the write operation in the memory device 150. The first calculation unit 1202 may calculate as the foreground write operation workload the number of write commands.

The controller 130 further includes a second calculation unit 1204 suitable for calculating the background operation workload during the background operation. The second calculation unit 1204 may calculate the background operation workload, for example, during a GC operation and or an WL operation. In this case, in order to perform the background operation including the copying or swapping of data, the second calculation unit 1204 may calculate as the background operation workload the storage capacity of memory blocks involved with the currently performed background GC or WL operation in the memory device 150.

The controller 130 may include an analysis unit 1208 suitable for calculating an execution ratio between the read and write operations of the memory device 150 based on the foreground read operation workload, the foreground write operation workload, and the background operation workload. For example, the analysis unit 1208 may calculate an execution ratio between the read and write operations based on the foreground operation workload. Also, as an example, the analysis unit 1208 may calculate an execution ratio between the read and write operations based on the storage capacity of memory blocks required for the read and write operations. Also, as an example, the analysis unit 1208 may calculate an execution ratio between the read and write operations based on the number of the read and write commands. The execution ratio between the read and write operations may be represented as in the following equations. In this case, the analysis unit 1208 may assign weight to the foreground read operation workload and the foreground write operation workload so that the read and write operations are performed prior to the background operation.

$$\begin{matrix}Write ratio = \frac{Σ Write block size}{Σ Read block size + Σ Write block size} & [ Equation 1 ] \\ Write ratio = \frac{Number of write requests}{Number of read requests + Number of write requests} & [ Equation 2 ] \\ Read ratio = \frac{Σ Read block size}{Σ Read block size + Σ Write block size} & [ Equation 3 ] \\ Read ratio = \frac{Number of read requests}{Number of read requests + Number of write requests} & [ Equation 4 ]\end{matrix}$$

Equation 1 represents the execution ratio of the write operation in terms of the storage capacity of memory blocks required for the read and write operations. Equation 2 represents the execution ratio of the write operation in terms of the number of read and write commands. Equation 3 represents the execution ratio of the read operation in terms of the storage capacity of memory blocks required for the read and write operations. Equation 4 represents the execution ratio of the read operation in terms of the number of the read and write commands.

The controller 130 may include a monitoring unit 1214 suitable for calculating the read and write memory available workloads of the memory device 150 currently available for the read and write operations. The monitoring unit 1214 may calculate as the read memory available workload the number of memory dies, planes, memory blocks, or pages involved with the currently to-be-performed read operation in the memory device 150. Furthermore, the monitoring unit 1214 calculates as the write memory available workload the number of memory dies, planes, memory blocks, or pages involved with the currently to-be-performed write operation in the memory device 150.

The monitoring unit 1214 may count numbers of the read and write commands transmitted to the memory device 150 through a queuing unit 1206. The monitoring unit 1214 may signal the completion of an operation in response to the read and write operation transmitted from the memory device 150 to the controller 130 through the queuing unit 1206. In this case, each of the read and write commands may include the addresses of memory dies, planes, memory blocks, or pages involved with the currently to-be-performed read and write operations.

The controller 130 may include a computation unit 1210 suitable for calculating the maximum read and write memory available workloads of the memory device 150. The computation unit 1210 may calculate the maximum read and write memory available workloads using the execution ratio between the read and write operations calculated by the analysis unit 1208 and a read and write operation parameters of the memory device 150.

In this case, the computation unit 1210 may calculate the maximum read and write memory available workloads using the storage capacity of a memory block involved with the currently to-be-performed read and write operations in the memory device 150 and a read time interval tR as the read operation parameter and using the storage capacity of a plane or page involved with the currently to-be-performed read and write operations in the memory device 150 and a program time interval tPROG as the write operation parameter. In this case, the maximum read and write memory available workloads may be represented as in the following equation 5.

$$Execution time = max ( R O E T , W O E T ) \\ R O E T = \frac{Read ratio ( \% )}{{N}_{RD} ⋆ block size / tR} \\ W O E T = \frac{100 - Read ratio ( \% )}{( {N}_{NANDS} - {N}_{RD} ) ⋆ ( Number of planes \times page size ) / tPROG} ) \qquad [ Equation 5 ]$$

Equation 5 represents an execution time during one of a read and write operations with maximum read and write memory available workloads. In Equation 5, “ROET” is the read operation execution time with the maximum read memory available workload, and “WOET” is the write operation execution time with the maximum write memory available workload. According to equation 5, the computation unit 1210 calculates the number (N_{RD}) of memory dies as the maximum read memory available workload, and the number (N_{NANDS}−N_{RD}) of memory dies as the maximum write memory available workload so that the execution time is minimized.

The controller 130 may include a scheduling unit 1212 suitable for scheduling priorities and workloads for the read and write operations in the memory device 150 based on the maximum read and write memory available workloads calculated by the computation unit 1210 and the current read and write memory available workloads calculated by the monitoring unit 1214.

In this case, the scheduling unit 1212 may dynamically determine the priorities of the read and write operations to the memory device 150 based on the maximum read and write memory available workloads and the current read and write memory available workloads. The scheduling unit 1212 may then dynamically determine the workloads for the read and write operations in the memory device 150 based on the determined priorities. The workloads for the read and write operations in the memory device 150 represent the number of memory dies, planes, memory blocks, or pages involved with the currently to-be-performed read and write operations in the memory device 150.

The controller 130 further includes the queuing unit 1206 suitable for generating a command for the memory device 150 so that the read and write operations are performed to the memory device 150 based on the workloads for of the read and write operations in the memory device 150 determined by the scheduling unit 1212, and queues the command for the memory device 150 to the memory device 150. In this case, the command for the memory device 150 includes the addresses of memory dies, planes, memory blocks, or pages of the memory device 150, on which the read and write operations are to be performed, based on the workloads for the read and write operations in the memory device 150 dynamically determined by the scheduling unit 1212.

For example, when the scheduling unit 1212 determines the priority of the read operation as being higher than the priority of the write operation and the analysis unit 1208 calculates the execution ratio between the read and write operations, for example, as 75:25, the scheduling unit 1212 determines the workloads for the read operation to be three memory dies, planes, memory blocks, or pages in the memory device 150 and the workloads for the write operation to be one memory die, plane, memory block, or page in the memory device 150. Then the controller 130 may perform the read and write operations to the memory device 150 based on the determined workloads for the read and write operations.

In this case, when the read memory available workload is greater than the write memory available workload, the controller 130 decreases the determined workloads for the read operation and increases the determined workloads for the write operation. For example, the controller 130 decreases the workloads for the read operation to be two memory dies, planes, memory blocks, or pages and increases the workloads for the write operation to be two memory dies, planes, memory blocks, or pages.

For another example, when the scheduling unit 1212 determines the priority of the read operation as being lower than the priority of the write operation and the analysis unit 1208 calculates the execution ratio between the read and write operations as 25:75, the scheduling unit 1212 determines the workloads for the read operation to be one memory die, plane, memory block, or page in the memory device 150, and the workloads for the write operation to be three memory dies, planes, memory blocks, or pages in the memory device 150. Then, the controller 130 performs the read and write operations to the memory device 150 based on the determined workloads for the read and write operations.

In this case, when the read memory available workload is smaller than a write memory available workload, the controller 130 increases the determined workloads for the read operation and decreases the determined workloads for the write operation. For example, the controller 130 increases the workloads for the read operation to be two memory dies, planes, memory blocks, or pages and decreases the workloads for the write operation to be two memory dies, planes, memory blocks, or pages.

For another example, when only the read command is provided from the host 102 and thus only the foreground read operation workload is calculated, which means that the scheduling unit 1212 determines the priority of the read operation as higher than the priority of the write operation and the analysis unit 1208 calculates the execution ratio between the read and write operations as 100:0, the scheduling unit 1212 determines the workloads for the read operation in the memory device 150 to be the maximum read memory available workload in the memory device 150 (e.g., four memory dies, planes, memory blocks, or pages) based on the maximum read memory available workload and the current read memory available workload, and the controller 130 performs the read operation to the memory device 150 based on the determined workloads for the read operation.

For another example, when only the write command is provided from the host 102 and thus only the foreground write operation workload is calculated, which means that the scheduling unit 1212 determines the priority of the read operation as being lower than the priority of the write operation and the analysis unit 1208 calculates the execution ratio between the read and write operations as 0:100, the scheduling unit 1212 determines the workloads for the write operation in the memory device 150 to be the maximum write memory available workload (e.g., four memory dies, planes, memory blocks, or pages) based on the maximum write memory available workload and the current write memory available workload, and the controller 130 performs the write operation to the memory device 150 based on the determined workloads for the write operation.

As described above, the memory system, according to an embodiment of the present invention, calculates the foreground operation workload corresponding to a received command, calculates the memory available workload involved with the currently to-be-performed foreground operation to the memory device 150, calculates a background operation workload required for a background operation performed to the memory device 150 during the foreground operation, dynamically determines the priorities of the foreground operation to the memory device 150 and workloads for the foreground operation in the memory device 150 based on the foreground operation workload, the memory available workload, and the background operation workload, and performs the foreground operation to the memory device 150 based on the dynamically determined priorities of the foreground operation to the memory device 150 and workloads for the foreground operations in the memory device 150.

As described above, the memory system, according to an embodiment of the present invention, calculates the foreground operation workload corresponding to a read and or write command, calculates the memory available workload involved with the currently to-be-performed read and write operations to the memory device 150, calculates a background operation workload required for the background operation performed to the memory device 150 during the foreground read and write operations, dynamically determines the priorities of the read and write operations to the memory device 150 and workloads for the read and write operations in the memory device 150 based on the foreground operation workload, the memory available workload, and the background operation workload, and performs the read and write operations to the memory device 150 based on the dynamically determined priorities of the read and write operations to the memory device 150 and workloads for the read and write operations in the memory device 150.

Accordingly, the memory system according to an embodiment of the present invention can maximize data processing performance. Furthermore, the memory system can improve performance by dynamically scheduling the read and write operations to the memory device 150 using a multi-level feedback queuing method, by which the read and write operations performed to the memory device 150 are monitored in a feedback way and the read and write commands for the memory device 150 are queued at the same time.

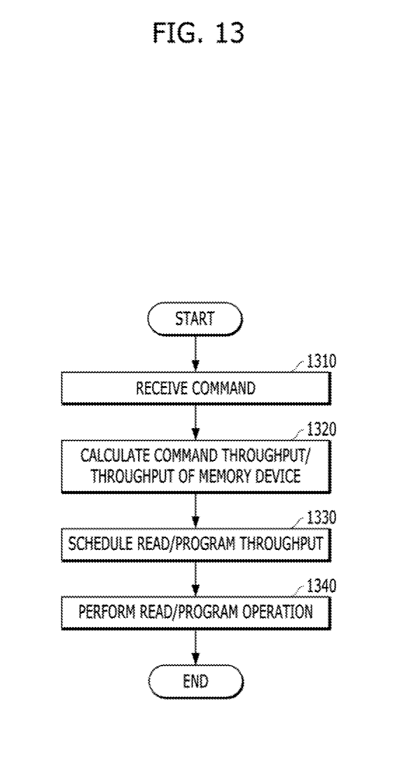

FIG. 13 is a flowchart illustrating an operational process of the memory system 110 of FIG. 1, according to an embodiment of the invention.

According to the embodiment of FIG. 13, the memory system 110 receives a command or commands, for example a read and or a write command(s) from the host 102 at step 1310. At step 1320, the memory system 110 respectively calculates the foreground operation workloads of the command operation such as, for example, for example read and or write operation(s) corresponding to the provided command or command(s), and the memory available workloads of the memory device 150 for the command operation(s).

Furthermore, at step 1330, the memory system 110 dynamically determines priorities and workloads for the read and write operations in the memory device 150 based on the foreground operation workload, the memory available workload, and the background operation workload.

At step 1340, the memory system 110 performs the command operations, e.g., the read and write operations to the memory device 150 based on the determined workloads for the read and write operations.

In this case, the calculation of the foreground operation workload as throughput corresponding to the command, the calculation of the memory available workload (i.e., the read memory available workload as the capability of the memory device 150 for the read and write operations, the calculation of the background operation workload of the memory device 150, and the dynamic scheduling of the read and write operations for the memory device 150 based on the foreground operation workload, the memory available workload, and the background operation workload have been described in detail with reference to FIG. 12, and thus a detailed description thereof is omitted.

The memory system and the operating method of the memory system according to the aforementioned embodiments of the present invention can minimize the complexity of the memory system, reduces peak performance work load, enhances stability of the data processing operation and increases the use efficiency of a memory device employed by the memory system.

Although various embodiments have been described for illustrative purposes, it will be apparent to those skilled in the art that various changes and modifications may be made without departing from the spirit and or scope of the invention as defined in the following claims.

What is claimed is:

1. A memory system, comprising:
a memory device; and
a controller suitable for:
performing a command operation to the memory device in response to a command,
calculating a foreground operation workload corresponding to the command,
calculating a memory available workload of the memory device for the command operation, and
dynamically determining priority and workload for the command operation based on the foreground operation workload and the memory available workload.

2. The memory system of claim 1,
wherein the command includes at least one of a read command and a write command, and
the foreground operation workload includes at least one of a foreground read operation workload corresponding to the read command and a foreground write operation workload corresponding to the write command.

3. The memory system of claim 2,
wherein the command operation includes a read operation and a write operation, and
the memory available workload includes a read memory available workload for the read operation and a write memory available workload for the write operation.

4. The memory system of claim 3, wherein the controller further calculates a background operation workload of the memory device involved with a currently performed background operation.

5. The memory system of claim 4, wherein the controller further calculates a maximum read and write memory available workloads of the memory device based on a parameter of the memory device for the read and write operations, the background operation workload, and the foreground read and write operation workloads.

6. The memory system of claim 5, wherein the controller dynamically determines priorities and workloads for the read and write operations based on the maximum read and write memory available workloads and the read and write memory available workloads.

7. The memory system of claim 6, wherein the memory device comprises a plurality of pages, a plurality of memory blocks comprising the plurality of pages, a plurality of planes comprising the plurality of memory blocks, and a plurality of memory dies comprising the plurality of plane; and
the controller determines a size or number of at least one of the memory dies, planes, memory blocks, and pages as the workloads for the read and write operations.

8. The memory system of claim 6,
wherein the controller determines the maximum read memory available workload as the workload for the read operation when only the read command is provided from the host, and
wherein the controller determines the maximum write memory available workload as the workload for the write operation when only the write command is provided from the host.

9. The memory system of claim 6, wherein the controller adjusts the workloads for the read and write operations based on the read and write memory available workloads for the read and write operations.

10. The memory system of claim 6, wherein the controller comprises:
a first calculation unit suitable for calculating the foreground read and write operation workloads;
a second calculation unit suitable for calculating the background operation workload;
a monitoring unit suitable for calculating the read and write memory available workloads by monitoring the read and write operations;
a computation unit suitable for calculating the maximum read and write memory available workloads; and
a scheduling unit suitable for dynamically determining the priorities and workloads for the read and write operations.

11. The memory system of claim 5, wherein the parameter comprises:
a size and time interval of the memory device for the read operation, and
a size and time interval of the memory device for the write operation.

12. An operating method of a memory system having a memory device, the method comprising:
performing a command operation to the memory device in response to a command,
calculating a foreground operation workload corresponding to the command,
calculating a memory available workload of the memory device for the command operation, and
dynamically determining priority and workload for the command operation based on the foreground operation workload and the memory available workload.

13. The operating method of claim 12,
wherein the command includes at least one of a read command and a write command,
the foreground operation workload includes at least one of a foreground read operation workload corresponding to the read command and a foreground write operation workload corresponding to the write command,
the command operation includes at least one of a read operation and a write operation, and
the memory available workload includes at least one of a read memory available workload for the read operation and a write memory available workload for the write operation.

14. The operating method of claim 13, further comprising calculating a background operation workload of the memory device involved with a currently performed background operation.

15. The operating method of claim 14, further comprising calculating a maximum read and write memory available workloads of the memory device based on a parameter of the memory device for the read and write operations, the background operation workload, and the foreground read and write operation workloads.

16. The operating method of claim 15, wherein the dynamically determining of the priority and workloads for the command operation includes determining priorities and workloads for the read and write operations based on the maximum read and write memory available workloads and the read and write memory available workloads.

17. The operating method of claim 16, wherein the memory device comprises a plurality of pages, a plurality of memory blocks comprising the plurality of pages, a plurality of planes comprising the plurality of memory blocks, and a plurality of memory dies comprising the plurality of planes, and
the dynamically determining of the workloads for the command operation is performed by determining a size or number of at least one of the memory dies, planes, memory blocks, and pages as the workloads for the read and write operations.

18. The operating method of claim 16,
wherein the dynamically determining of the workloads for the command operation is performed by determining the maximum read memory available workload as the workload for the read operation when only the read command is provided from the host, and
the dynamically determining of the workloads for the command operation is performed by determining the maximum write memory available workload as the workload for the write operation when only the write command is provided from the host.

19. The operating method of claim 16, wherein the dynamically determining of the workloads for the command operation includes adjusting the workloads for the read and write operations based on the read and write memory available workloads for the read and write operations.

20. The operating method of claim 15, wherein the parameter comprises:
a size and time interval of the memory device for the read operation, and
a size and time interval of the memory device for the write operation.
